(19) United States
(12) Patent Application Publication
(10) Pub. No.: US 2022/0020383 A1
(43) Pub. Date: Jan. 20, 2022

(54) METHOD FOR ADDING WATERMARK INFORMATION, METHOD FOR EXTRACTING WATERMARK INFORMATION, AND ELECTRONIC DEVICE

(71) Applicant: BEIJING DAJIA INTERNET INFORMATION TECHNOLOGY CO., LTD., Beijing (CN)

(72) Inventors: Chen ZHANG, Beijing (CN); Xiguang ZHENG, Beijing (CN); Liang GUO, Beijing (CN)

(21) Appl. No.: 17/489,603

(22) Filed: Sep. 29, 2021

Related U.S. Application Data
(63) Continuation of application No. PCT/CN2020/130460, filed on Nov. 20, 2020.

(30) Foreign Application Priority Data
Feb. 4, 2020 (CN) 202010080065.7

(51) Int. Cl. G10L 19/018

(52) U.S. Cl. CPC G10L 19/018

(57) ABSTRACT

Provided is a method for adding watermark information. The method includes: acquiring M first audio signal frames in a first audio signal; acquiring N watermark information items in watermark information; determining M*N adding parameters; acquiring M second audio signal frames added with the watermark information based on the M*N adding parameters; and determining a second audio signal based on the M second signal frames added with the watermark information.

### CROSS-REFERENCE TO RELATED APPLICATION

This application is a continuation application of International Application No. PCT/CN2020/130460, filed on Nov. 20, 2020, which claims the priority of Chinese Application No. 202010080065.7, filed on Feb. 4, 2020. Both applications are incorporated by reference herein.

### TECHNICAL FIELD

The present disclosure relates to the field of computer technologies, and in particular, to a method for adding watermark information, a method for extracting watermark information, and an electronic device.

### BACKGROUND

With the development of computer technologies and the increasingly high requirements for the security of audio signals, watermark information is added to an audio signal to reveal the identity of a publisher of the audio signal, thus avoiding leakage of the audio signal.

### SUMMARY

According to one aspect of embodiments of the present disclosure, a method for adding watermark information is provided. The method includes:

acquiring NI first audio signal frames in a first audio signal, where M is a positive integer larger than 1;

acquiring N watermark information items in watermark information, where N is a positive integer larger than 1;

determining M*N adding parameters, wherein each of the adding parameters corresponds to one of the watermark information items and one of the first audio signal frames;

acquiring M second audio signal frames added with the watermark information based on the M*N adding parameters, wherein the second audio signal frame added with the watermark information is acquired by adding the N watermark information items to the first audio signal frame based on N adding parameters, wherein the N adding parameters correspond to the first audio signal frame and correspond to N watermark information items; and

determining a second audio signal based on the M second signal frames added with the water mark information.

According to another aspect of the embodiments of the present disclosure, a method for extracting watermark information is provided. The method includes:

acquiring a second audio signal added with watermark information;

determining N adding parameters in a second audio signal frame of the second audio signal, wherein each of the adding parameters corresponds to one watermark information item in the watermark information, and N is a positive integer;

acquiring N decoded watermark information items, wherein one decoded watermark information item corresponds to one watermark information item; and

extracting watermark information from the second audio signal frame based on the N adding parameters and the N decoded watermark information items.

According to another aspect of the embodiments of the present disclosure, an electronic device for adding watermark information is provided. The electronic device includes:

at least one processor; and

a volatile or nonvolatile memory configured to store at least one instruction executable by the at least one processor;

wherein the at least one processor, when executing the at least one instruction, is caused to perform the method for adding watermark information as described in the above aspect.

According to another aspect of the embodiments of the present disclosure, an electronic device for extracting watermark information is provided. The electronic device includes:

at least one processor; and

a volatile or nonvolatile memory configured to store at least one instruction executable by, the at least one processor;

wherein the at least one processor, when executing the at least one instruction, is caused to perform the method for extracting watermark information as described in the above aspect.

According to another aspect of the embodiments of the present disclosure, a non-transitory computer-readable storage medium storing at least one instruction therein is provided. The at least one instruction, when executed by a processor of an electronic device, causes the electronic device to perform the method for adding watermark information as described in the above aspect.

According to another aspect of the embodiments of the present disclosure, a non-transitory computer-readable storage medium storing at least one instruction therein is provided. The at least one instruction, when executed by a processor of an electronic device, causes the electronic device to perform the method for extracting watermark information as described in the above aspect.

### BRIEF DESCRIPTION OF THE DRAWINGS

FIG. 1 is a flowchart of a method for adding watermark information according to an embodiment;

FIG. 2 is a flowchart of a method or extracting watermark information according to an embodiment;

FIG. 3 is a flowchart of another method for adding watermark information according to an embodiment;

FIG. 4 is a schematic diagram of a target position of a watermark information item according to an embodiment;

FIG. 5 is a schematic diagram of a target position of another watermark information item according to an embodiment;

FIG. 6 is a block diagram of adding watermark information to amplitude information according to an embodiment;

FIG. 7 is a block diagram of adding watermark information o phase information according to an embodiment;

FIG. 8 is a block diagram of adding watermark information to amplitude information and phase information according to an embodiment;

FIG. 9 is a flowchart of another method for extracting watermark information according to an embodiment;

FIG. 10 is a block diagram of extracting watermark information from amplitude information according to an embodiment;

FIG. 11 is a block diagram of extracting watermark information from phase information according to an embodiment;

FIG. 12 is a block diagram of extracting watermark information from amplitude information and phase information according to an embodiment;

FIG. 13 is a block diagram of an apparatus for adding watermark information according to an embodiment;

FIG. 14 is a block diagram of another apparatus for adding watermark information according to an embodiment;

FIG. 15 is a block diagram of an apparatus for extracting watermark information according to an embodiment;

FIG. 16 is a block diagram of another apparatus for extracting watermark information according to an embodiment;

FIG. 17 is a block diagram of a terminal according to an embodiment; and

FIG. 18 is a block diagram of a server according to an embodiment;

### DETAILED DESCRIPTION

A method for adding watermark information and a method for extracting watermark information according to embodiments of the present disclosure are applicable to a plurality of scenarios.

For example, a publisher of an audio signal can add watermark information to the audio signal by using a method for adding watermark information according to the embodiments of the present disclosure to protect the audio signal. When the audio signal is embezzled by others, the publisher can extract the watermark information from the audio signal by using the method for extracting watermark information according to the embodiments of the present disclosure to prove that the audio signal belongs to the publisher.

The method for adding watermark information and the method for extracting watermark information according to embodiments of the present disclosure are executed by any electronic device. Any electronic device adds watermark information to an audio signal, or extracts watermark information from an audio signal added with the watermark information.

The electronic device is a terminal. The terminal may be various types of terminals such as a portable terminal, a pocket terminal, and a handheld terminal, e.g., a mobile phone, a computer, and a tablet computer. Alternatively, the electronic device is a server. The server is one server, or a server cluster consisting of a plurality of servers, or a cloud computing service center.

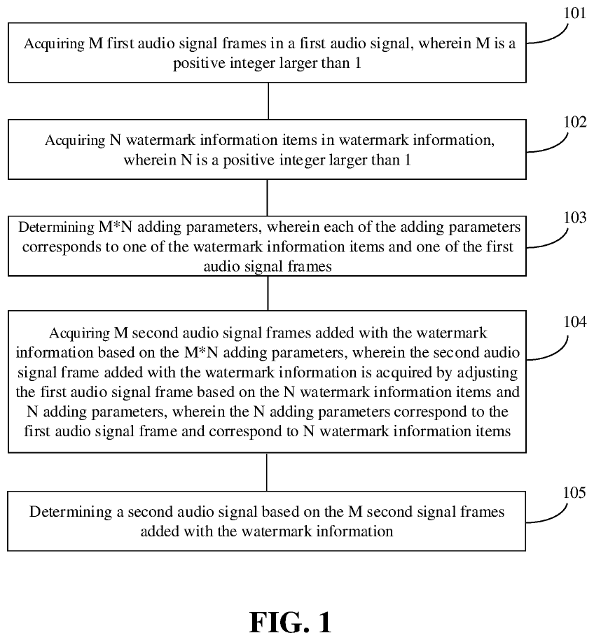

FIG. 1 is a flowchart of a method for adding watermark information according to an embodiment. Referring to FIG. 1, the method is executed by an electronic device and includes the following processes.

In 101, M first audio signal frames in a first audio signal are acquired, where M is a positive integer larger than 1.

In 102, N watermark information items in watermark information are acquired, where N is a positive integer larger than 1.

In 103, M*N adding parameters are determined, wherein each of the adding parameters corresponds to one of the watermark information items and one of the first audio signal frames.

In 104, M second audio signal frames added with the watermark information are acquired based on the M*N adding parameters, wherein the second audio signal frame added with the watermark information is acquired by adjusting the first audio signal frame based on the N watermark information items and N adding parameters, wherein the N adding parameters correspond to the first audio signal frame and correspond to N watermark information items.

In 105, a second audio signal is determined based on the M second signal frames added with the watermark information.

In the method according to embodiments of the present disclosure, the N watermark information items are added to each of the first audio signal frames, such that each of the second audio signal frames includes the full watermark information, thereby ensuring the integrity of the watermark information added to the audio signal. Even in the case that the operation on the audio signal affects some audio signal frames in the audio signal, the full watermark information can still be extracted from other audio signal frames, thus improving the attack resistance of the watermark information.

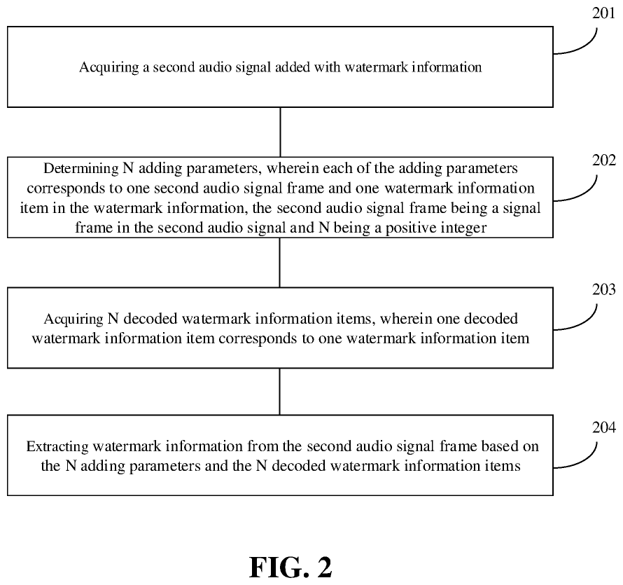

FIG. 2 is a flowchart of a method for extracting watermark information according to an embodiment. Referring to FIG. 2, the method is executed by an electronic device and includes the following processes.

In 201, a second audio signal added with watermark information is acquired.

In 202, N adding parameters are determined from a second audio signal frame in the second audio signal, wherein each of the adding parameters corresponds to one watermark information item in the watermark information, and N is a positive integer.

In 203, N decoded watermark information items are acquired, wherein one decoded watermark information item corresponds to one watermark information item.

In 204, watermark information is determined based on the N adding parameters and the N decoded watermark information items.

In the method according to embodiments of the present disclosure, the watermark information can be extracted from any second audio signal frame in the second audio signal, and it is unnecessary to extract a watermark information item from each of the second audio signal frames and then acquire the watermark information by combining the extracted watermark information items. Even in the case that the operation on the audio signal affects some audio signal frames in the audio signal, the full watermark information can still be extracted from other audio signal frames, thus improving the attack resistance of the watermark information.

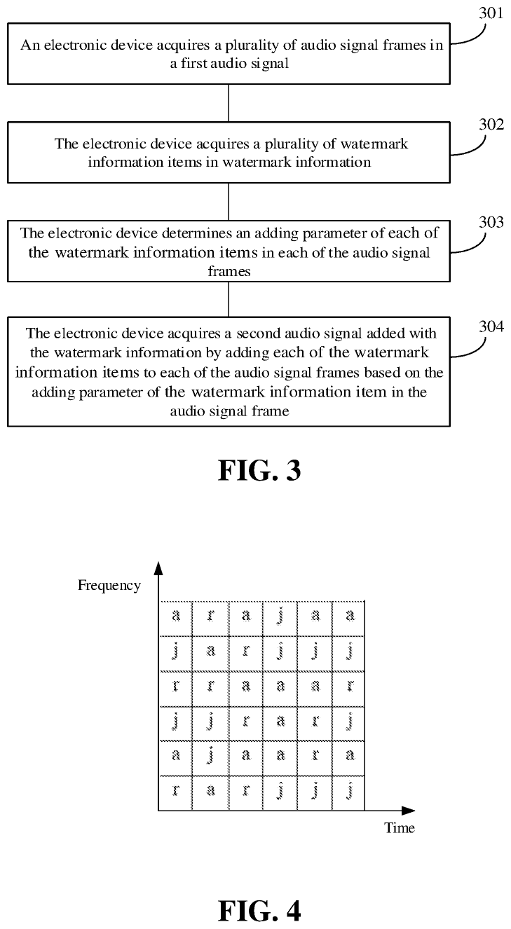

FIG. 3 is a flowchart of another method for adding watermark information according to an embodiment. Referring to FIG. 3, the method is executed by an electronic device and includes the following processes.

In 301, the electronic device acquires a plurality of audio signal frames in a first audio signal.

In embodiments of the present disclosure, the first audio signal acquired by the electronic device is an audio signal captured by the electronic device, or an audio signal sent by another electronic device to the electronic device, or an audio signal acquired in other ways. The audio signal frame in the first audio signal may be referred to as a first audio signal frame, and the first audio signal includes a plurality of audio signal frames, that is, the first audio signal frame includes M first audio signal frames, M being a positive integer larger than 1. The electronic device acquires the plurality of audio signal frames in the first audio signal, that is, the electronic device acquires M first audio signal frames in the first audio signal.

For example, a publisher of the audio signal provides the audio signal to the electronic device. By using the method for adding watermark information according to embodiments of the present disclosure, the electronic device adds watermark information to the audio signal. The publisher of the audio signal can subsequently publish the audio signal added with the watermark information.

In some embodiments, the electronic device needs to add watermark information to a time-frequency domain audio signal. Therefore, the electronic device needs to convert a time domain audio signal into a time-frequency domain audio signal.

The electronic device acquires the first audio signal by transforming a third audio signal. The first audio signal is a time-frequency domain audio signal, and the third audio signal is a time domain audio signal.

The transformation performed on the time domain audio signal may be a short-time Fourier transform (STFT), wavelet transform, or the like.

For example, the electronic device transforms a time domain audio signal into a time-frequency domain audio signal by short-time Fourier transform based on the formula of:

X(n,k)=STFT(x(t));

wherein n represents an audio signal frame, 0<n≤N, N represents a total frame quantity of the audio signal frames in a time-frequency domain audio signal, k represents a central frequency of the audio signal frame, 0<k≤K, and K represents a total quantity of time-frequency points in the audio signal frame. X (n,k) represents the time-frequency domain audio signal acquired upon the transformation, x (t) represents the time domain audio signal before the transformation, and STFT (·) represents performing short-time Fourier transform on x (t).

In some embodiments, in response to acquiring the first audio signal frame, the electronic device acquires parameter information of the first audio signal frame, wherein the parameter information includes at least one of amplitude information or phase information.

For example, amplitude information in a first audio signal frame is acquired based on the formula of:

Mag(n,k)=abs(X(n,k));

wherein Mag (n,k) represents amplitude information, X (n,k) represents a time-frequency domain audio signal, and abs(·) represents acquiring the amplitude information.

Phase information in a first audio signal frame is acquired based on the formula of:

Pha(n,k)=ang(X(n,k));

wherein Pha (n,k) represents phase information, X (n,k) represents a time-frequency domain audio signal, and ang(·) represents acquiring the phase information.

In 302, the electronic device acquires a plurality of watermark information items in watermark information.

The watermark information is arbitrary. The content of the watermark information is not limited in embodiments of the present disclosure. The watermark information includes N watermark information items, and each of the watermark information items includes the same or different information content. N is a positive integer larger than 1.

In embodiments of the present disclosure, the electronic device acquires converted watermark information by performing at least binary conversion on the watermark information. In this case, the converted watermark information is binary, and the converted watermark information includes one or more bits. Then, a plurality of watermark information items are acquired by using each bit in the converted watermark information as one watermark information item, or a plurality of watermark items are acquired by using a combination of a plurality of bits in the converted watermark information as one watermark information item. In some embodiments, the converted watermark information includes N bits, and N watermark information items are acquired by determining each bit in the converted watermark information as one watermark information item.

In some embodiments, the electronic device acquires converted watermark information by converting the watermark information multiple times. For example, the electronic device acquires binary watermark information by performing the binary conversion on the watermark information and acquires converted information corresponding to the binary watermark information according to a reference conversion relationship as converted watermark information. That is, the electronic device determines converted information corresponding to the binary watermark information according to the reference conversion relationship, and determines the converted information as the converted watermark information.

The watermark information is information in any form other than the binary form, for example, the watermark information is information in a form of a decimal system, a character string, or the like. The binary watermark information is acquired by converting the watermark information once, and the converted watermark information is acquired by converting the binary watermark information according to the reference conversion relationship.

The reference conversion relationship includes converted binary numbers corresponding to original binary numbers. The original binary number and the converted binary number includes the same quantity or different quantities of bits, and the quantity is any number.

For example, in the reference conversion relationship, converted binary number 01 corresponds to 1, and converted binary number 10 corresponds to 0. In the case that the binary watermark information is “1001,” the converted information acquired by converting the binary watermark information is “01101001.” Alternatively, in the reference conversion relationship, converted binary number 01 corresponding to 0, and converted binary number 10 corresponds to 1; in this case, the converted information acquired by converting the binary watermark information “1001” is “10010110.”

The converted watermark information is acquired by converting the binary watermark information once or multiple times. In the case that the binary watermark information is converted multiple times according to the reference conversion relationship, the security of the watermark information can be further improved.

In some embodiments, the electronic device acquires converted watermark information corresponding to the watermark information and acquires a plurality of watermark information items by using each bit in the converted watermark information as one watermark information item.

For example, in the case that the converted watermark information acquired by the electronic device is “1001,” four watermark information items are acquired, which are “1,” “0,” “0,” and “1.”

In some embodiments, the electronic device combines a plurality of adjacent bits in the converted watermark information into one watermark information item, wherein each of the watermark information items includes the same quantity of bits.

For example, the electronic device combines two adjacent bits into one watermark information item. In the case that the acquired converted watermark information is “10010110,” four watermark information items are acquired, which are “10,” “01,” “01,” and “10.”

In 303, the electronic device determines an adding parameter of each of the watermark information items in each of the audio signal frames.

In embodiments of the present disclosure, the electronic device determines adding parameters of the plurality of watermark information items in each of the first audio signal frames, that is, the electronic device determines M*N adding parameters. The adding parameter represents a parameter of a watermark information item that needs to be considered in the case that the watermark information item is added to the first audio signal frame. Each of the adding parameters corresponds to one of the watermark information items and one of the first audio signal frames, and for any watermark information item, the watermark information item has the same or different adding parameter in different first audio signal frames.

For example, the watermark information includes a watermark information item 1, a watermark information item 2, and a watermark information item 3, and the first audio signal includes a first audio signal frame 1 and a first audio signal frame 2, then an adding parameter of the watermark information item 1 in the first audio signal frame 1, an adding parameter of the watermark information item 2 in the first audio signal frame 1, an adding parameter of the watermark information item 3 in the first audio signal frame 1, an adding parameter of the watermark information item 1 in the first audio signal frame 2, an adding parameter of the watermark information item 2 in the first audio signal frame 2, and an adding parameter of the watermark information item 3 in the first audio signal frame 2 need to be determined, i.e. 6 adding parameters are determined.

In some embodiments, the adding parameter includes a target position. The target position represents a position of a time frequency point, in the first audio signal frame, at which the watermark information item is added. In the adding parameter, one or more target positions are defined. That is, one watermark information item in one first audio signal frame has at least one target position. The target position is expressed in the form of a coordinate mask or the like.

For one watermark information item, the watermark information item has a completely different target position in each of the first audio signal frames, or the watermark information item has the same target position in some of the first audio signal frames, and has different target positions in other first audio signal frames. For an electronic device that does not know the way of adding the watermark information, it is difficult for the electronic device to extract the watermark information from the first audio signal frame, thus improving the security.

For a plurality of watermark information items, different watermark information items correspond to the same quantity or different quantities of target positions in one first audio signal frame, or different watermark information items correspond to the same total quantity or different total quantities of target positions in the M first audio signal frames.

The electronic device assigns a different quantity of target positions to each of the watermark information items according to a weight of each of the watermark information items, wherein the weight represents the importance of the watermark information item. The more important a watermark information item is in the watermark information, the greater the weight of the watermark information item. For example, in the case that the weight of a watermark information item in the watermark information is greater than the weights of other watermark information items, during the assignment of target positions, the quantity of target positions assigned to the watermark information item is greater than the quantity of target positions assigned to any of other watermark information items.

In some embodiments, the adding parameter further includes an information strength, wherein the information strength represents the strength of the watermark information item added to the first audio signal frame. The information strength is any strength. The higher the information strength, the easier it is for the electronic device to extract the watermark information from the audio signal subsequently; the lower the information strength, the more difficult it is for the electronic device to extract the watermark information from the audio signal subsequently. In the case that the information strength is excessively low, the electronic device may fail to extract the full watermark information subsequently.

For one watermark information item, a total information strength is acquired by accumulating the information strength of the watermark information item in each of the first audio signal frames, and the watermark information can be extracted from the audio signal only in response to the total information strength reaching a first information strength.

For a plurality of watermark information items, each of the watermark information items corresponds to the same or different information strength.

The electronic device assigns a different information strength to each of the watermark information items according to the weight of the watermark information item. For example, the watermark information includes two watermark information items. In the case that the first watermark information item is more important, it is impossible to determine the watermark information without the first watermark information item, while the second watermark information item is merely additional information, and information expressed in the watermark information can still be determined without the second watermark information item. In this case, a higher information strength is assigned to the first watermark information item, and a lower information strength is assigned to the second watermark information item.

A corresponding quantity of target positions and a corresponding information strength are assigned to each of the watermark information items according to the weight of the watermark information item, thereby improving the flexibility of adding the watermark information.

In some embodiments, the electronic device encrypts the watermark information according to a reference key corresponding to the watermark information; and determines the adding parameter of each of the watermark information items in each of the first audio signal frames based on the encrypted watermark information and a reference function, that is, determines M*N adding parameters. The electronic device encrypts the watermark information by using the reference key, such that the watermark information is more secure. The reference key is set in advance to encrypt the watermark information. The reference function is configured to acquire the adding parameter of the watermark information item in the first audio signal frame.

The electronic device inputs the encrypted watermark information to the reference function, and the reference function processes the encrypted watermark information to determine the adding parameter of each of the watermark information items in each of the first audio signal frames.

In some embodiments, the electronic device sets the adding parameter of each of the watermark information items in each of the first audio signal frames. For one watermark information item, the watermark information item has the same or different target positions in each of the first audio signal frames.

In some embodiments, the electronic device sets the information strength of each of the watermark information items at each target position in each of the first audio signal frames. That is, for any watermark information item, the information strength of the watermark information item corresponds to the target position of the watermark information in the first audio signal frame, and the electronic device sets a corresponding information strength for each target position of the watermark information item in the first audio signal frame. The watermark information item can have a plurality of corresponding target positions in a first audio signal frame, and the electronic device needs to set the information strength of the watermark information item at each target position respectively. Optionally, the information strengths of different target positions of the same watermark information item in the same first audio signal frame are the same, or the information strengths of different target positions of the same watermark information item in the same first audio signal frame are not completely the same, or the information strengths of different target positions of the same watermark information item in the same first audio signal frame are different from each other. The plurality of watermark information items have the same or different information strengths.

For example, as shown in FIG. 4, the watermark information includes three watermark information items, wherein “a” represents the first watermark information item, “j” represents the second watermark information item, and “r” represents the third watermark information item. In the figure, the vertical coordinate represents frequency, and the horizontal coordinate represents time. In FIG. 4, the audio signal is divided into 6 first audio signal frames in a time domain, and 6 time frequency points are determined in each of the first audio signal frames in a frequency domain. The watermark information item has different positions in respective first audio signal frames.

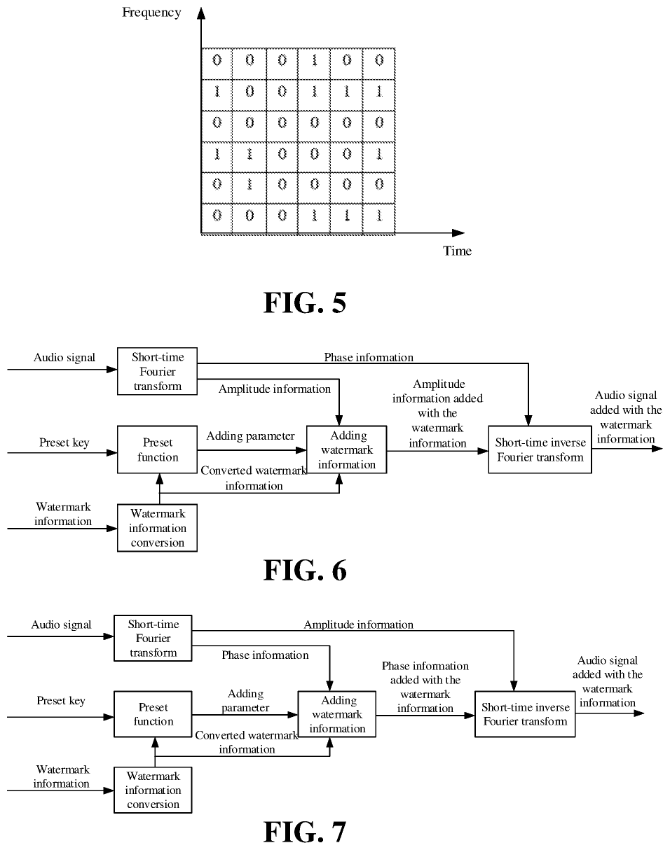

In addition, as shown in FIG. 5, for the second watermark information item j in FIG. 4, in the first audio signal frame, a position of a time frequency point corresponding to the second watermark information item is represented by 1, and a position of the time frequency point not corresponding to the second watermark information item is represented by 0, thereby acquiring an array consisting of 0 and 1, that is, a position array of the second watermark information item j. Subsequently, the corresponding target position of the second watermark information item j in each of the first audio signal frames is determined based on the position array.

It should be noted that this embodiment of the present disclosure is described by using an example in which 301 is performed before 302 and 303. In another embodiment, 302 and 303 are performed first, and then 301 is performed. The sequence of performing the processes is not limited in embodiments of the present disclosure.

In 304, the electronic device acquires a second audio signal added with the watermark information by adding each of the watermark information items to each of the audio signal frames based on the adding parameter of the watermark information item in the audio signal frame.

That is, the electronic device acquires M second audio signal frames added with the watermark information based on the M*N adding parameters, and determines the second audio signal based on the M second signal frames. The second audio signal frame is acquired by adding the N watermark information items to the first audio signal frame based on the N adding parameters. The N adding parameters correspond to the N watermark information items. After acquiring the plurality of second audio signal frames, the electronic device can acquire the second audio signal by combining the plurality of second audio signal frames together according to a time sequence of the plurality of second audio signal frames.

In embodiments of the present disclosure, for adding the watermark information, the electronic device uses a masking effect of the human ear, that is, the human ear is insensitive to small adjustments on the amplitude information or phase information in the first audio signal frame. Therefore, the electronic device adds the watermark information to the first audio signal frame by adjusting the amplitude information or phase information of the first audio signal frame, and then acquires the second audio signal frame added with the watermark information, such that the user is unaware of changes in the second audio signal added with the watermark information.

In some embodiments, the electronic device acquires parameter information of the M first audio signal frames. The electronic device adjusts the parameter information of each of the first audio signal frames based on the N watermark information items and N adding parameters corresponding to the first audio signal frame, thereby acquiring the second audio signal frame with the adjusted parameter information, i.e. the second audio signal frame added with watermark information. The parameter information includes at least one of amplitude information or phase information.

The electronic device adds, based on the adding parameter of any watermark information item in any first audio signal frame, the watermark information item to the first audio signal frame by using the formula of:

$$\{ \begin{matrix}{P}_{w} ( n , k ) = P ( n , k ) \cdot {Mask}_{b} ( n , k ) \cdot x , if I ( b ) = 1 \\ {P}_{w} ( n , k ) = P ( n , k ) \cdot {Mask}_{b} ( n , k ) / y , if I ( b ) = 0\end{matrix} ;$$

wherein n represents the first audio signal frame, k represents a central frequency of the first audio signal frame, P (n,k) represents parameter information of the first audio signal frame, P_{w}(n,k) represents the parameter information of the second audio signal frame added with the watermark information, I(b) represents a b^{th} watermark information item in the watermark information, Mask_{b} (n,k) represents the target position corresponding to the b^{th} watermark information item, b represents a positive integer, and x and y represent reference values.

The electronic device adds the N watermark information items in the watermark information to the first audio signal frame by using the formula respectively. In the case that the watermark information item is 1, the electronic device multiplies the parameter information corresponding to the target position by the reference value x; in the case that the watermark information item is 0, the electronic device divides the parameter information corresponding to the target position by the reference value y. The reference value x and the reference value y are any values, wherein x and y are the same or different.

In some embodiments, the electronic device respectively adds, based on the target position and information strength of each of the watermark information items in each of the first audio signal frames, the watermark information item matching the information strength to the corresponding target position in the first audio signal frame. That is, the electronic device acquires the second audio signal frame added with the watermark information by adjusting the first audio signal frame based on the N watermark information items and the target positions and the information strengths of the N adding parameters.

The electronic device adds, based on the target position and information strength of any watermark information item in any first audio signal frame, the watermark information item to the first audio signal frame by using the formula of:

$$\{ \begin{matrix}{P}_{w} ( n , k ) = P ( n , k ) \cdot {Mask}_{b} ( n , k ) \cdot {10}^{\frac{{s}_{b}}{20}} , if I ( b ) = 1 \\ {P}_{w} ( n , k ) = P ( n , k ) \cdot {Mask}_{b} ( n , k ) / 1 {0}^{\frac{{s}_{b}}{20}} , if I ( b ) = 0\end{matrix} ;$$

wherein n represents the first audio signal frame, k represents a central frequency of the first audio signal frame, P (n,k) represents parameter information of the first audio signal frame, P_{w}(n,k) represents the parameter information of the second audio signal frame added with the watermark information, I(b) represents a b^{th} watermark information item in the watermark information, Mask_{b} (n,k) represents the target position corresponding to the b^{th} watermark information item, s_{b} represents the information strength corresponding to the b^{th} watermark information item, and b is a positive integer.

The electronic device adds the watermark information item to the audio signal by using the formula, and determines a corresponding coefficient

$${10}^{\frac{{S}_{b}}{20}}$$

based on the information strength s_{b} of each of the watermark information items in the first audio signal. In the case that the watermark information item is 1, the electronic device multiplies the parameter information corresponding to the target position by the coefficient; and in the case that the watermark information item is 0, the electronic device divides the parameter information corresponding to the target position by the coefficient.

In embodiments of the present disclosure, the electronic device determines the corresponding coefficient based on the information strength s_{b} of each of the watermark information items in the audio signal. In the case that the coefficient is relatively large, where the electronic device adds the watermark information item to the audio signal by using the formula, the parameter information of the audio signal may change greatly, which affects the audio signal. In the case that the coefficient is relatively small, the electronic device only adjusts the parameter information of the audio signal, and the adjustment does not affect the audio signal. Moreover, according to the masking effect, in the case that the amplitude information or the phase information of the audio signal is slightly adjusted, the human ear is insensitive to the adjustment, such that the user is unaware of the added watermark information. Therefore, the coefficient determined based on the information strength is a relatively small value, such that the amplitude information or the phase information of the audio signal is slightly adjusted.

For each of the first audio signal frames, in the case that the electronic device adds, based on the target position and information strength of each of the watermark information items in the first audio signal frame, the watermark information item matching the information strength to the corresponding target position, that is, in the case that the electronic device respectively adds, based on the target position and information strength of each of the watermark information items in each of the first audio signal frames, the watermark information item matching the information strength to the corresponding target position in the first audio signal frame, the added watermark information item does not affect the first audio signal frame since the value of the information strength is controllable.

In some embodiments, in response to acquiring the second audio signal added with the watermark information, the electronic device acquires a fourth audio signal by inversely transforming the second audio signal. The fourth audio signal is a time domain audio signal.

For example, the electronic device inversely transforms the second audio signal by using the formula of:

x_{w}(t)=ISTFT(X_{w}(n,k))=ISTFT(Mag_{w}(n,k)·e^{j·Pha(n,k)});

wherein x_{w}(t) represents a time domain audio signal added with the watermark information and ISTFT(·) represents performing short-time inverse Fourier transform.

In addition, the electronic device adds the watermark information to the amplitude information of each of the first audio signal frames, or to the phase information of each of the first audio signal frames, or to both the amplitude information and phase information of each of the first audio signal frames.

For example, as shown in FIG. 6, the electronic device adds the watermark information to the amplitude information of the first audio signal frame. The electronic device acquires a time-frequency domain audio signal by performing short-time Fourier transform on the audio signal, i.e., acquires amplitude information and phase information of the time-frequency domain audio signal frame; the electronic device acquires converted watermark information by performing binary conversion on the watermark information; in addition, the electronic device encrypts the converted watermark information according to a reference key corresponding to the watermark information, inputs the encrypted watermark information to a reference function, determines an adding parameter of each of the watermark information items according to the reference function, adds the converted watermark information to the amplitude information of the first audio signal frame based on the adding parameter of each of the watermark information items, acquires a time-frequency domain audio signal added with the watermark information based on the plurality of amplitude information added with watermark information and the phase information corresponding to each of the plurality of amplitude information, and acquires a time domain audio signal added with the watermark information by performing short-time inverse Fourier transform on the time-frequency domain audio signal added with the watermark information.

For example, as shown in FIG. 7, the electronic device adds the watermark information to the phase information of the first audio signal frame. The process of the electronic device acquiring the phase information, the amplitude information, the converted watermark information and the adding parameter of each of the watermark information items is described in FIG. 6, which is not described herein again. In response to acquiring the adding parameter of each of the watermark information items, the electronic device adds the converted watermark information to the phase information of the first audio signal frame based on adding parameter of each of the watermark information items, acquires a time-frequency domain audio signal added with the watermark information based on the plurality of amplitude information added with watermark information and the phase information corresponding to each of the plurality of amplitude information, and acquires a time domain audio signal added with the watermark information by performing short-time inverse Fourier transform on the time-frequency domain audio signal added with the watermark information.

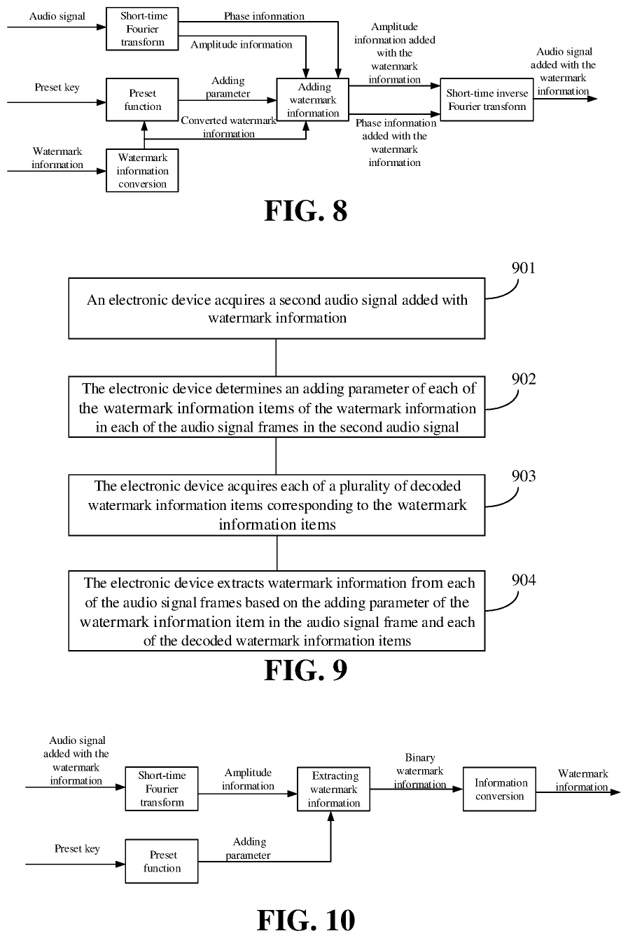

For example, as shown in FIG. 8, the electronic device adds the watermark information to the amplitude information and phase information of the first audio signal frame. The process of the electronic device acquiring the phase information, the amplitude information, the converted watermark information and the adding parameter of each of the watermark information items is described in FIG. 6, which is not described herein again. In response to acquiring the adding parameter of each of the watermark information items, the electronic device adds the converted watermark information to the phase information and the amplitude information of the first audio signal frame based on adding parameter of each of the watermark information items, acquires a time-frequency domain audio signal added with the watermark information based on the plurality of phase information added with watermark information and the plurality of amplitude information added with watermark information, and acquires a time domain audio signal added with the watermark information by performing short-time inverse Fourier transform on the time-frequency domain audio signal added with the watermark information.

In embodiments of the present disclosure, the electronic device adds the watermark information to the audio signal; the watermark information is considered as a weak signal, and the audio signal is considered as a strong signal, that is, a weak signal is superimposed on a strong signal.

In addition, in the case that the watermark information is added to the first audio signal by using the method for adding watermark information according to embodiments of the present disclosure, resampling, clipping, lossy coding, filtering, or other operations are performed on the obtained second audio signal to delete some second audio signal frames in the second audio signal or delete partial second audio signal that belongs to specific frequency bands. Since each of the second audio signal frames includes the full watermark information, in the case that the electronic device needs to extract the watermark information from the audio signal subsequently, the full watermark information is extracted from the remaining audio signal.

Resampling refers to the conversion of an original sampling rate to a new sampling rate to meet the requirements for different sampling rates of the audio signal. The resampling process may cause a loss of information in the audio signal. Clipping refers to the removal of a portion of the audio signal. Lossy coding means compressing the audio signal to discard some information less important in the audio signal. Lossy coding includes encoders such as Moving Picture Experts Group Audio Layer III (MP3). Filtering refers to the removal of partial signal in some specific frequency bands from the audio signal.

In the related technology, the audio signal includes a plurality of audio signal frames. The watermark information includes a plurality of watermark information items, and the plurality of audio signal frames correspond to the plurality of watermark information items in a one-to-one relationship. Then, each of the watermark information items in the watermark information is added to the corresponding audio signal frame respectively, that is, each of the audio signal frames may be added with one watermark information item. The clipping, lossy coding, or other operations on the audio signal may affect some audio signal frames in the audio signal, and thus affect the watermark information items added to the audio signal frames, i.e., affect the integrity of the watermark information.

According to the method provided by embodiments of the present disclosure, the N watermark information items are added to each of the first audio signal frames, such that the each of the second audio signal frames includes the full watermark information. In the case that the second audio signal is under attack, the integrity of the watermark information added to the second audio signal is ensured, thus improving the attack resistance of the watermark information.

Moreover, during adding the watermark information to the audio signal, the information strength of the watermark information is controlled according to the actual application scenario, and different information strengths are applicable to different watermark information items. The amount of each of the watermark information items in the watermark information can further be controlled. Different watermark information items are of different amounts, thus further improving the attack resistance of the watermark information. Moreover, as the information strength and amount can be controlled, the flexibility of adding the watermark information is improved.

FIG. 9 is a flowchart of a method for extracting watermark information according to an embodiment. Referring to FIG. 9, the method is executed by an electronic device and includes the following processes.

In 901, the electronic device acquires a second audio signal added with watermark information.

In embodiments of the present disclosure, the second audio signal acquired by the electronic device is an audio signal sent by another electronic device to the electronic device, or an audio signal acquired in other ways. The second audio signal includes a plurality of audio signal frames, and the audio signal frame in the second audio signal may be referred to as a second audio signal frame.

In some embodiments, the electronic device needs to extract watermark information from a time-frequency domain audio signal. Therefore, the electronic device needs to convert a time domain audio signal into a time-frequency domain audio signal.

In some embodiments, the electronic device acquires the second audio signal by transforming a fourth audio signal, wherein the second audio signal is a time-frequency domain audio signal, and the fourth audio signal is a time domain audio signal. The method for transforming the fourth audio signal to the second audio signal is similar to the method for transforming the third audio signal to the first audio signal in the above embodiment, which is not described herein again.

For example, the electronic device transforms a time domain audio signal into a time-frequency domain audio signal through short-time Fourier transform based on the formula of:

X_{w}(n,k)=STFT(x_{w}(t));

wherein n represents the second audio signal frame, 0<n≤N, N represents a total frame quantity of the second audio signal frames in a time-frequency domain audio signal, k represents a central frequency of the second audio signal frame, 0<k≤K, and K represents a total quantity of time-frequency points in the second audio signal frame. X_{w}(n,k) represents the time-frequency domain audio signal acquired upon the transformation, X_{w} (t) represents the time domain audio signal before the transformation, and STFT(·) represents performing short-time Fourier transform on x (t).

In some embodiments, in response to acquiring the second audio signal, the electronic device acquires each of a plurality of second audio signal frames in the second audio signal, and then acquires parameter information of the second audio signal frame, wherein the parameter information includes at least one of amplitude information or phase information.

For example, amplitude information in a second audio signal frame is acquired based on the formula of:

Mag_{w}(n,k)=abs(X_{w}(n,k));

wherein Mag_{w}(n,k) represents amplitude information, X_{w}(n,k) represents a time-frequency domain audio signal, and abs(·) represents acquiring the amplitude information.

Phase information in a second audio signal frame is acquired based on the formula of:

Pha_{w}(n,k)=ang(X_{w}(n,k));

wherein Pha_{w}(n,k) represents phase information, X_{w}(n,k) represents a time-frequency domain audio signal, and ang(·) represents acquiring the phase information.

In 902, the electronic device determines an adding parameter of each of a plurality of watermark information items of the watermark information in an audio signal frame in the second audio signal.

In some embodiments, the electronic device determines N adding parameters, where N represents a quantity of the plurality of watermark information items. The adding parameter at least includes a target position and an information strength, and each of the adding parameters corresponds to one second audio signal frame and one watermark information item in the watermark information. The adding parameter in 902 is the same as the adding parameter in 303 above. The electronic device acquires the adding parameter of each of the watermark information items in the second audio signal frame in the second audio signal by using a method similar to that in 303.

In some embodiments, the electronic device acquires decrypted watermark information by decrypting the watermark information according to a reference key corresponding to the watermark information, and determines the adding parameter of each of the watermark information items in each of the audio signal frames according to the reference key and a reference function.

The electronic device inputs the reference key to the reference function, and the reference function processes the reference key to determine the adding parameter of each of the watermark information items in the second audio signal frame.

In some embodiments, the adding parameter is preset by the electronic device, and the electronic device directly acquires the adding parameter when extracting the watermark information.

The process of acquiring the adding parameter is similar to that in 303, except that the watermark information is encrypted first in the case that the adding parameter is acquired based on the reference key in 303, while in 902, the watermark information needs to be decrypted first.

In 903, the electronic device acquires a plurality of decoded watermark information items corresponding to the watermark information items.

In some embodiments, the electronic device acquires N decoded watermark information items. The decoded watermark information item is an information item that corresponds to the watermark information item and is configured to extract the watermark information. One decoded watermark information item corresponds to one watermark information item. The decoded watermark information item is preset by the electronic device.

The electronic device sets the decoded watermark information corresponding to the watermark information according to the determined way of adding the watermark information, thereby determining the decoded watermark information item corresponding to each of the watermark information items.

In 904, the electronic device extracts the watermark information from the audio signal frame based on the adding parameter of each of the watermark information items in the audio signal frame and the decoded watermark information items.

In embodiments of the present disclosure, during extraction of the watermark information, the electronic device extracts the watermark information from the second audio signal frame based on the adding parameters and the decoded watermark information items.

In some embodiments, the adding parameter includes a target position and an information strength. In this case, the electronic device extracts the watermark information from the second audio signal frame based on the target position and information strength of each of the watermark information items in the second audio signal frame, and the decoded watermark information items.

In some embodiments, the electronic device acquires parameter information of the second audio signal frame, acquires target parameter information of the corresponding target position in the second audio signal frame based on the target position of each of the watermark information items in second the audio signal frame, and extracts the watermark information from the target parameter information based on the adding parameter of the watermark information item in the second audio signal frame and the decoded watermark information item corresponding to the watermark information item.

In order to acquire the target parameter information, the electronic device acquires converted parameter information of the corresponding target position in the second audio signal frame based on the target position of each of the watermark information items in the second audio signal frame, i.e. acquires a plurality of converted parameter information in the second audio signal frame based on the target positions of the N adding parameters, and the electronic device acquires original parameter information corresponding to the converted parameter information according to a reference conversion relationship as the target parameter information. That is, the electronic device determines a plurality of original parameter information corresponding to the converted parameter information according to the reference conversion relationship, and determines the original parameter information as the target parameter information. One piece of the original parameter information corresponds to one piece of the converted parameter information.

Each piece of the original parameter information and the converted parameter information is binary information, and the reference conversion relationship includes converted binary numbers corresponding to original binary numbers. The second audio signal frame is an audio signal frame added with the watermark information acquired by using the method for adding watermark information. In the process of adding the watermark information, the original information is converted into the converted information according to the reference conversion relationship. Therefore, the parameter information of the corresponding target position in the second audio signal frame is the converted parameter information. The converted parameter information is subsequently converted according to the reference conversion relationship to acquire the corresponding original parameter information, to serve as the target parameter information.

For example, in the reference conversion relationship, converted binary number corresponding to original binary number 1 is 10, and converted binary number corresponding to original binary number 0 is 01. The converted parameter information is converted into corresponding target parameter information. In the case that the converted parameter information is “10010110,” the acquired target parameter information is “1001.”

In some embodiments, the electronic device acquires target parameter information of the corresponding target position in the second audio signal frame based on the target position of each of the watermark information items in the second audio signal frame, that is, based on target positions of the N adding parameters.

For example, the electronic device determines the target parameter information based on the formula of:

P_{w}^{b}(n,k)=P_{w}(n,k)·Mask_{b}(n,k);

wherein P_{w}^{b}(n,k) represents target parameter information of the corresponding target position of the b^{th} watermark information item in the n^{th} second audio signal frame, P_{w}(n,k) represents parameter information of the n^{th} second audio signal frame, and Mask_{b} (n,k) represents the target position of the b^{th} watermark information item in the second audio signal frame.

As for the amplitude information, target amplitude information is determined based on the formula of:

Mag_{w}^{b}(n,k)=Mag_{w}(n,k)·Mask_{b}(n,k);

wherein Mag_{w}^{b} (n,k) represents target amplitude information of the corresponding target position of the b^{th} watermark information item in the n^{th} second audio signal frame, and Mag_{b}, (n,k) represents amplitude information of the n^{th} second audio signal frame.

As for the phase information, target phase information is determined based on the formula of:

Pha_{w}^{b}(n,k)=Pha_{w}(n,k)·Mask_{b}(n,k);

wherein Pha_{w}^{b}(n,k) represents target phase information of the corresponding target position of the b^{th} watermark information item in the n^{th} second audio signal frame, and Pha_{w}(n,k) represents phase information of the n^{th} second audio signal frame.

Then, the electronic device determines relevancy of watermark information items corresponding to any two pieces of target parameter information adjacent to each other based on the any two pieces of target parameter information and two of the decoded watermark information items corresponding to the any two pieces of target parameter information. The relevancy is configured to determine whether the second audio signal frame is added with a watermark information item, and in the case that the second audio signal frame is added with watermark information items, extract the watermark information items from the second audio signal frame.

In some embodiments, the electronic device determines the relevancy based on the formula of:

C=P_{w}^{e,f}·W^{e,f};

wherein C represents the relevancy, P_{w}^{e,f} represents target parameter information acquired by combining target parameter information corresponding to an e^{th} watermark information item and target parameter information corresponding to an f^{th} watermark information item, W^{e,f} represents a decoded watermark information item acquired by combining two of the decoded watermark information items corresponding to P_{w}^{w,f}, and the e^{th} watermark information item and the f^{th} watermark information item represent any two watermark information items adjacent to each other.

When the electronic device determines the relevancy according to the formula, in the case that the audio signal is not added with watermark information, P_{w}^{e,f} and W^{e,f} are irrelevant, and thus the calculated relevancy is 0, and it is determined that the audio signal is not added with watermark information. In the case that the relevancy is not equal to 0, it is determined that the audio signal is added with watermark information, and then watermark information items corresponding to any two pieces of target parameter information are extracted from the second audio signal frames based on the determined relevancy.

In some embodiments, in the case that the relevancy is a first reference value, the electronic device extracts watermark information items 1 from the second audio signal frame; alternatively, in the case that the relevancy is a second reference value, the electronic device extracts watermark information items 0 from the second audio signal frame. The first reference value and the second reference value are any values not equal to 0. The first reference value is different from the second reference value. The first reference value and the second reference value may be determined according to practical applications.

In some embodiments, for each of the second audio signal frames, the electronic device determines the relevancy corresponding to the watermark information items based on the target position and information strength of each of the watermark information items, the any two pieces of target parameter information adjacent to each other, and the two of the decoded watermark information items corresponding to the any two pieces of target parameter information by using the formula of:

C=P_{w}^{e,f}·W^{e,f}=(P^{e,f}+W^{e,f})·W^{e,f}=P^{e,f}·W^{e,f}+(n+m)s²;

wherein n represents a quantity of target positions corresponding to an e^{th} watermark information item, m represents a quantity of target positions corresponding to an f^{th} watermark information item, s represents an information strength of the e^{th} watermark information item and the f^{th} watermark information item, P^{e,f} represents parameter information acquired by combining parameter information corresponding to the e^{th} watermark information item and parameter information corresponding to the f^{th} watermark information item before the watermark information is added.

The formula above for determining the relevancy is adjusted, and the formula is established:

$$\frac{C}{( n + m ) {s}^{2}} = \frac{{P}^{e , f} \cdot {W}^{e , f}}{( n + m ) {s}^{2}} + 1 ;$$

$$\vert \frac{C}{( n + m ) {s}^{2}} \vert$$

is further acquired. In the case that

$$\vert \frac{C}{( n + m ) {s}^{2}} \vert$$

is not less than a reference threshold, it is considered that the watermark information items extracted based on the relevancy are correct. In the case that the relevancy is the first reference value, the watermark information items extracted from the second audio signal frame are 1; in the case that the relevancy is the second reference value, the watermark information items extracted from the second audio signal frame are 0. The reference threshold is any value greater than 0 and less than 1.

In the case that

$$\vert \frac{C}{( n + m ) {s}^{2}} \vert$$

is less than the reference threshold, watermark information items are extracted from the second audio signal frame based on the relevancy and confidence. The confidence represents credibility of the watermark information items extracted based on the relevancy.

The confidence is acquired by using the formula of:

$$conf = min ( 1 , \vert \frac{C}{( n + m ) {s}^{2}} \vert / T ) ;$$

wherein conf represents the confidence, and min (·) represents taking a minimum value.

In some embodiments, the electronic device is provided with a database. The database includes watermark information and an audio signal added with the watermark information, to indicate that the audio signal belongs to a publisher of the watermark information. In response to extracting the watermark information from the audio signal by using the method in embodiments of the present disclosure, the electronic device queries the watermark information and the corresponding audio signal in the database based on the watermark information, to determine whether the database includes the watermark information, thereby determining the publisher of the audio signal.

In the case that the corresponding watermark information is not found in the database based on the watermark information, the electronic device acquires new watermark information by replacing the watermark information item having minimum confidence with another watermark information item based on the confidence of each of the watermark information items, and then queries the database based on the new watermark information. Because the watermark information items are binary, during replacement of one watermark information item with another watermark information item, 0 is replaced with 1, or 1 is replaced with 0.

In addition, in response to extracting the watermark information from the second audio signal frame, the electronic device determines, based on whether the watermark information is added in the amplitude information or the phase information, whether the watermark information is extracted from the amplitude information or the phase information.

In one example, as shown in FIG. 10, the electronic device has added the watermark information to the amplitude information of the second audio signal frame. In this case, the electronic device extracts the watermark information from the amplitude information of the audio signal. The electronic device acquires a time-frequency domain audio signal by performing short-time Fourier transform on the audio signal added with the watermark information, and then acquires amplitude information of the time-frequency domain audio signal frame; the electronic device determines the adding parameter of the watermark information according to the reference key and the reference function, extracts binary watermark information from the amplitude information based on the adding parameter of the watermark information, and acquires the corresponding watermark information by converting the binary watermark information.

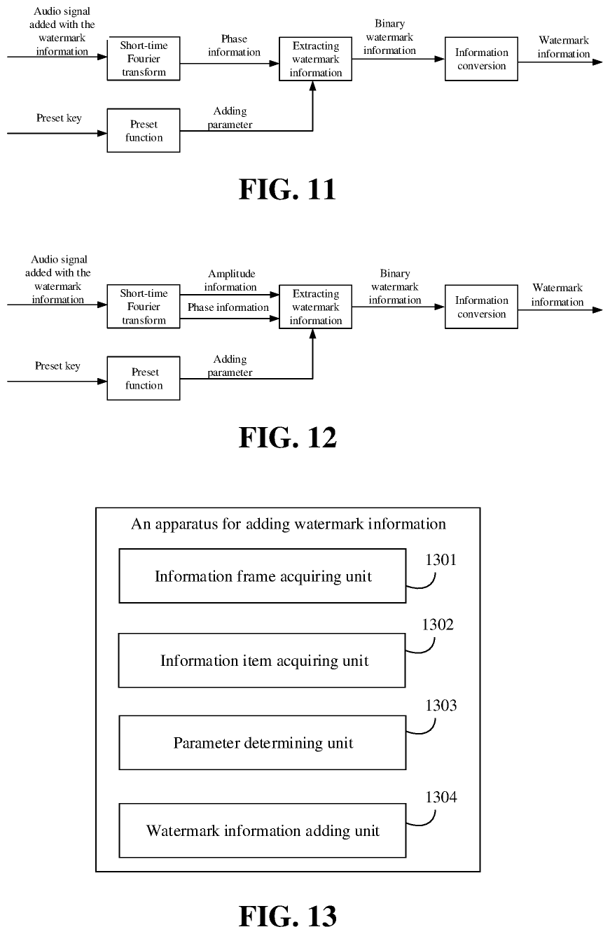

In another example, as shown in FIG. 11, the electronic device has added the watermark information to the phase information of the second audio signal frame. In this case, the electronic device extracts the watermark information from the phase information of the audio signal. The electronic device acquires a time-frequency domain audio signal by performing short-time Fourier transform on the audio signal added with the watermark information, and then acquires phase information of the time-frequency domain audio signal frame; the electronic device determines the adding parameter of the watermark information according to the reference key and the reference function, extracts binary watermark information from the phase information based on the adding parameter of the watermark information, and acquires the corresponding watermark information by converting the binary watermark information.

In another example as shown in FIG. 12, the electronic device has added the watermark information to the amplitude information and the phase information of the second audio signal frame. In this case, the electronic device extracts the watermark information from the amplitude information and the phase information of the audio signal. The electronic device acquires a time-frequency domain audio signal by performing short-time Fourier transform on the audio signal added with the watermark information, and then acquires amplitude information of the time-frequency domain audio signal frame; the electronic device determines an adding parameter of the watermark information according to a reference key and a reference function, extracts binary watermark information respectively from the amplitude information and phase information based on the adding parameter of the watermark information, and acquires the corresponding watermark information by converting the binary watermark information.

In embodiments of the present disclosure, converted watermark information corresponding to watermark information is acquired according to a method for generating watermark information; the converted watermark information is added to an audio signal according to the method for adding watermark information; and the watermark information is extracted from the audio signal according to the method for extracting watermark information. Based on the method for generating watermark information, the method for adding watermark information, and the method for extracting watermark information, a full audio watermark system is formed.

It should be noted that any second audio signal frame is used as an example for description in this embodiment of the present disclosure. In another embodiment, the method for extracting watermark information according to embodiments of the present disclosure may be performed on a plurality of second audio signal frames in the audio signal, and thus watermark information is acquired from the plurality of second audio signal frames.

According to the method provided by embodiments of the present disclosure, the watermark information can be extracted from any second audio signal frame in the second audio signal, and it is unnecessary to extract a watermark information item from each of the second audio signal frames and acquire the watermark information by combining the extracted watermark information items. Even in the case that the operation on the audio signal affects some audio signal frames in the audio signal, the full watermark information can still be extracted from other audio signal frames, thus improving the attack resistance of the watermark information.

Moreover, in embodiments of the present disclosure, during extraction of the watermark information, it is unnecessary to acquire an audio signal without watermark information and use as a reference, and the watermark information can be extracted from the second audio signal frame merely based on the adding parameters of the watermark information and the decoded watermark information items.

Moreover, the confidence is further set. The credibility of the extracted watermark information item is determined based on the value of the confidence. In the case that the extracted watermark information is not completely correct and the correct watermark information needs to be acquired, a watermark information item with smaller confidence can be replaced based on the value of the confidence, thereby acquiring the correct watermark information.

FIG. 13 is a block diagram of an apparatus for adding watermark information according to an embodiment. Referring to FIG. 13, the apparatus includes a signal frame acquiring unit 1301, an information item acquiring unit 1302, a parameter determining unit 1303, and a watermark information adding unit 1304.

The signal frame acquiring unit 1301 is configured to acquire M first audio signal frames in a first audio signal, where M is a positive integer larger than 1.

The information item acquiring unit 1302 is configured to acquire N watermark information items in watermark information, where N is a positive integer larger than 1.

The parameter determining unit 1303 is configured to determine M*N adding parameters, wherein each of the adding parameters corresponds to one of the watermark information items and one of the first audio signal frames.

The watermark information adding unit 1304 is configured to acquire M second audio signal frames added with the watermark information based on the M*N adding parameters, wherein the second audio signal frame added with the watermark information is acquired by adding the N watermark information items to the first audio signal frame based on N adding parameters, wherein the N adding parameters correspond to the first audio signal frame and correspond to N watermark information items.

The watermark information adding 1304 is further configured to determine a second audio signal based on the M second signal frames added with the watermark information.

According to the apparatus according to this embodiment of the present disclosure, the N watermark information items are added to each of the first audio signal frames, such that each of the second audio signal frames includes the full watermark information, thereby ensuring the integrity of the watermark information added to the audio signal. Even in the case that the operation on the audio signal affects some audio signal frames in the audio signal, the full watermark information can still be extracted from other audio signal frames, thus improving the attack resistance of the watermark information.

In some embodiments, the adding parameter includes a target position and an information strength, and the watermark information adding unit 1304 is further configured to acquire the second audio signal frame added with the watermark information by adding each of the N watermark information items in the first audio signal frame based on the target position and the information strength.

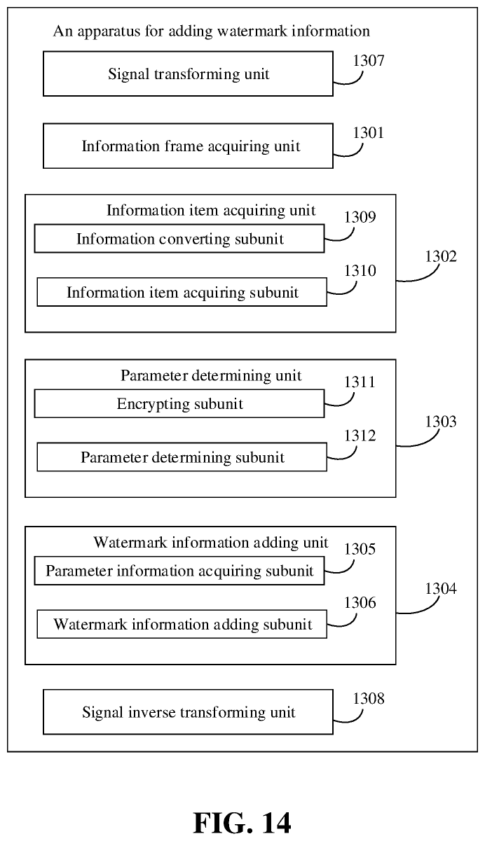

In some embodiments, as shown in FIG. 14, the watermark information adding unit 1304 includes a parameter information acquiring subunit 1305 and a watermark information adding subunit 1306.

The parameter information acquiring subunit 1305 is configured to acquire parameter information of the first audio signal frames, wherein the parameter information includes at least one of amplitude information or phase information.

The watermark information adding subunit 1306 is configured to acquire the second audio signal frame added with the watermark information by adjusting the parameter information of the first audio signal frame based on the N adding parameters and the N watermark information items.

In some embodiments, as shown in FIG. 14, the apparatus further includes a signal transforming unit 1307.

The signal transforming unit 1307 is configured to acquire the first audio signal by transforming a third audio signal; wherein the third audio signal is a time domain audio signal, and the first audio signal is a time-frequency domain audio signal.

In some embodiments, as shown in FIG. 14, the apparatus further includes a signal inverse transforming unit 1308.

The signal inverse transforming unit is configured to acquire a fourth audio signal by inversely transforming the second audio signal, wherein the fourth audio signal is a time domain audio signal.

In some embodiments, as shown in FIG. 14, the information item acquiring unit 1302 includes an information converting subunit 1309 and an information item acquiring subunit 1310.

The information converting subunit 1309 is configured to acquire converted watermark information by performing binary conversion on the watermark information.

The information item acquiring subunit 1310 is configured to determine the N watermark information items based on N bits in the converted watermark information, wherein each bit corresponds to one watermark information item.

In some embodiments, the information converting subunit 1309 is further configured to acquire binary watermark information by performing the binary conversion on the watermark information; and determine converted watermark information corresponding to the binary watermark information according to a reference conversion relationship, wherein the reference conversion relationship comprises converted binary numbers corresponding to original binary numbers.

In some embodiments, the adding parameter includes a target position, and the watermark information adding unit 1304 is further configured to adjust the first audio signal frame by using the formula of:

$$\{ \begin{matrix}{P}_{w} ( n , k ) = P ( n , k ) \cdot {Mask}_{b} ( n , k ) \cdot x , & if I ( b ) = 1 \\ {P}_{w} ( n , k ) = P ( n , k ) \cdot {Mask}_{b} ( n , k ) / y , & if I ( b ) = 0\end{matrix} ;$$

wherein n represents the first audio signal frame, k represents a central frequency of the first audio signal frame, P (n,k) represents parameter information of the first audio signal frame, P_{w}(n,k) represents the parameter information of the second audio signal frame added with the watermark information, I(b) represents a b^{th} watermark information item in the watermark information, Mask_{b}(n,k) represents the target position corresponding to the b^{th} watermark information item, b represents a positive integer, and x and y represent reference values.

In some embodiments, the watermark information adding unit 1304 is further configured to adjust the first audio signal frame by using the formula of:

$$\{ \begin{matrix}{P}_{w} ( n , k ) = P ( n , k ) \cdot {Mask}_{b} ( n , k ) \cdot {10}^{\frac{{s}_{b}}{20}} , & if I ( b ) = 1 \\ {P}_{w} ( n , k ) = P ( n , k ) \cdot {Mask}_{b} ( n , k ) / {10}^{\frac{{s}_{b}}{20}} , & if I ( b ) = 0\end{matrix} ;$$

wherein n represents the first audio signal frame, k represents a central frequency of the first audio signal frame, P (n,k) represents parameter information of the first audio signal frame, P_{w}(n,k) represents the parameter information of the second audio signal frame added with the watermark information, I(b) represents a b^{th} watermark information item in the watermark information, Mask_{b} (n,k) represents the target position corresponding to the b^{th} watermark information item, and s_{b} represents the information strength corresponding to the b^{th} watermark information item.

In some embodiments, as shown in FIG. 14, the parameter determining unit 1303 includes an encrypting subunit 1311 and a parameter determining subunit 1312.

The encrypting subunit 1311 is configured to encrypt the watermark information according to a reference key corresponding to the watermark information.

The parameter determining subunit 1312 is configured to determine the M*N adding parameters based on the encrypted watermark information and a reference function.

The operations performed by the units of the apparatus in the above embodiment have been described in detail in the embodiments of the related method, which are not described herein again.

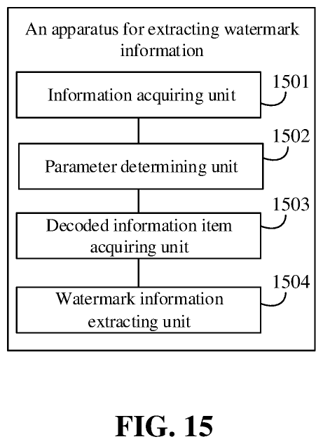

FIG. 15 is a block diagram of an apparatus for extracting watermark information according to an embodiment. Referring to FIG. 15, the apparatus includes a signal acquiring unit 1501, a parameter determining unit 1502, a decoded information item acquiring unit 1503, and a watermark information extracting unit 1504.

The signal acquiring unit 1501 is configured to acquire a second audio signal added with watermark information.

The parameter determining unit 1502 is configured to determine N adding parameters in a second audio signal frame of the second audio signal, wherein each of the adding parameters corresponds to one watermark information item in the watermark information, and N is a positive integer.

The decoded information item acquiring unit 1503 is configured to acquire N decoded watermark information items, wherein one decoded watermark information item corresponds to one watermark information item.

The watermark information extracting unit 1504 is configured to extract watermark information from the second audio signal frame based on the N adding parameters and the N decoded watermark information items.

According to the apparatus according to this embodiment of the present disclosure, the watermark information can be extracted from any second audio signal frame in the second audio signal, and it is unnecessary to extract a watermark information item from each of the second audio signal frames and then acquire the watermark information by combining the extracted watermark information items. Even in the case that the operation on the audio signal affects some audio signal frames in the audio signal, the full watermark information can still be extracted from other audio signal frames, thus improving the attack resistance of the watermark information.

In some embodiments, the adding parameter further includes a target position and an information strength, and the watermark information extracting unit 1504 is further configured to extract the watermark information from the second audio signal frame based on the target positions and information strengths of the N adding parameters in the second audio signal frame and the N decoded watermark information items.

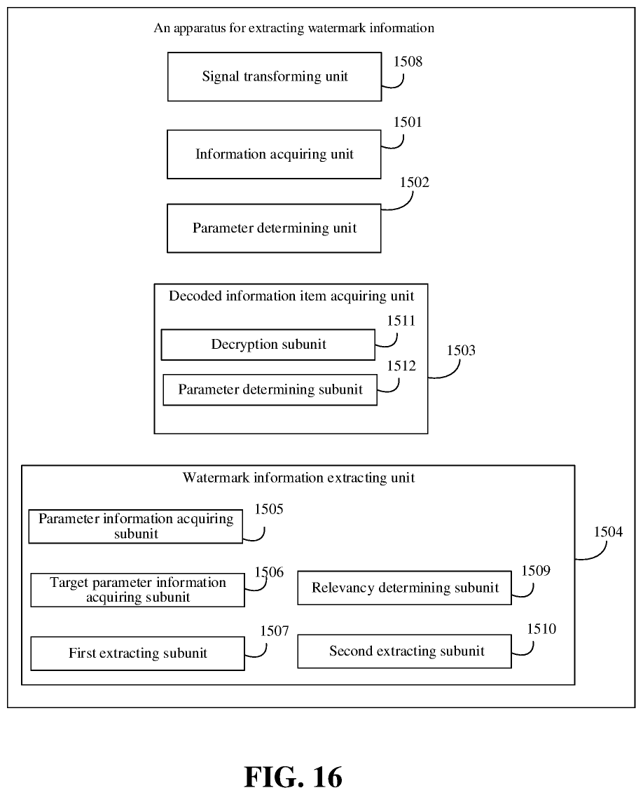

In some embodiments, as shown in FIG. 16, the watermark information extracting unit 1504 includes a parameter information acquiring subunit 1505, a target parameter information acquiring subunit 1506, and a first extracting subunit 1507.

The parameter information acquiring subunit 1505 is configured to acquire parameter information of the second audio signal frame, wherein the parameter information includes at least one of amplitude information or phase information.

The target parameter information acquiring subunit 1506 is configured to acquire a plurality of target parameter information in the second audio signal frame based on the target positions of the N adding parameters.

The first extracting subunit 1507 is configured to extract the watermark information from the plurality of target parameter information based on the N adding parameters and the N decoded watermark information items.

In some embodiments, as shown in FIG. 16, the target parameter information acquiring subunit 1506 is further configured to acquire a plurality of converted parameter information in the second audio signal frame based on the target positions of the N adding parameters; and determine a plurality of original parameter information according to a reference conversion relationship, and determining the original parameter information as the target parameter information, wherein one piece of the original parameter information corresponds to one piece of the converted parameter information, the reference conversion relationship includes converted information corresponding to the original information, and both the original information and the converted information are binary information.

In some embodiments, as shown in FIG. 16, the apparatus further includes a signal transforming unit 1508.

The signal transforming unit 1508 is configured to acquire the second audio signal by transforming a fourth audio signal; wherein the fourth audio signal is a time domain audio signal, and the second audio signal is a time-frequency domain audio signal.

In some embodiments, the adding parameter further includes a target position, as shown in FIG. 16, the watermark information extracting unit 1504 includes the target parameter information acquiring subunit 1506, a relevancy determining subunit 1509, and a second extracting subunit 1510.

The target parameter information acquiring subunit 1506 is further configured to acquire a plurality of target parameter information in the second audio signal frame based on the target position of each of the watermark information items in the second audio signal frame.

The relevancy determining subunit 1509 is configured to determine relevancy of watermark information items corresponding to any two pieces of target parameter information adjacent to each other based on the any two pieces of target parameter information and two of the decoded watermark information items corresponding to the any two pieces of target parameter information.

The second extracting subunit 1510 is configured to extract the watermark information items corresponding to the any two pieces of target parameter information from the second audio signal frame based on the relevancy.

In some embodiments, as shown in FIG. 16, the relevancy determining subunit 1509 is further configured to determine the relevancy by using the formula of:

C=P_{w}^{e,f}·W^{e,f};

wherein C represents the relevancy, P_{w}^{e,f} represents target parameter information acquired by combining target parameter information corresponding to an e^{th} watermark information item and target parameter information corresponding to an f^{th} watermark information item, W^{e,f} represents a decoded watermark information item acquired by combining two of the decoded watermark information items corresponding to P_{w}^{e,f} and the e^{th} watermark information item and the f^{th} watermark information item represent any two watermark information items adjacent to each other.

In some embodiments, as shown in FIG. 16, the second extracting subunit 1510 is further configured to extract watermark information items 1 from the second audio signal frame in response to the relevancy being a first reference value; or extract watermark information items 0 from the second audio signal frame in response to the relevancy being a second reference value.

In some embodiments, the adding parameter further includes an information strength, and the watermark information extracting unit 1504 is further configured to determine the relevancy by using the formula of:

C=P_{w}^{e,f}·W^{e,f}=(P^{e,f}+W^{e,f})·W^{e,f}=P^{e,f}·W^{e,f}+(n+m)s²

wherein n represents a quantity of target positions corresponding to an e^{th} watermark information item, m represents a quantity of target positions corresponding to an f^{th} watermark information item, s represents an information strength of the e^{th} watermark information item and the f^{th} watermark information item, P^{e,f} represents parameter information acquired by combining parameter information corresponding to the e^{th} watermark information item and parameter information corresponding to the f^{th} watermark information item before the watermark information is added; and

extract watermark information items 1 from the audio signal frame in response to

$$\vert \frac{C}{( n + m ) {s}^{2}} \vert$$

being not less than a reference threshold and the relevancy being a first reference value; or

extract watermark information items 0 from the audio signal frame in response to

$$\vert \frac{C}{( n + m ) {s}^{2}} \vert$$

being not less than the reference threshold and the relevancy being a second reference value.

In some embodiments, the watermark information extracting unit 1504 is further configured to extract watermark information items from the second audio signal frame based on the relevancy and confidence in response to

$$\vert \frac{C}{( n + m ) {s}^{2}} \vert$$

being less than the reference threshold, wherein the confidence represents credibility of the watermark information items extracted based on the relevancy.

In some embodiments, as shown in FIG. 16, the parameter determining unit 1502 includes a decryption subunit 1511 and a parameter determining subunit 1512.

The decryption subunit 1511 is configured to acquire decrypted watermark information by decrypting the watermark information according to a reference key corresponding to the watermark information.

The parameter determining subunit 1512 is configured to determine the N adding parameters according to the reference key and a reference function.

Details of operations performed by the units of the apparatus in the above embodiment have been described in detail in the embodiments of the related method, which are not described herein again.

In an exemplary embodiment, an electronic device is further provided. The electronic device includes at least one processor, and a volatile or non-volatile memory configured to store at least one instruction executable by the at least one processor. The at least one processor, when executing the at least one instruction, is caused to perform the above method for adding watermark information and the method for extracting watermark information.

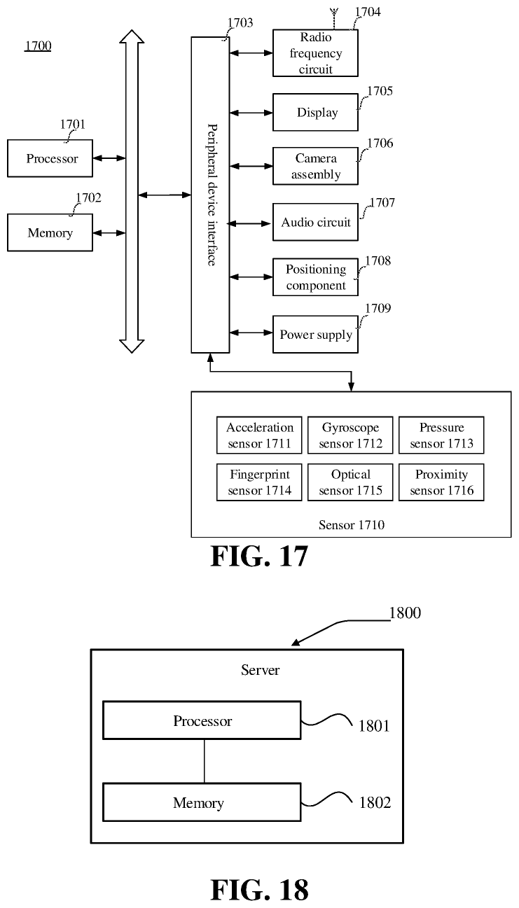

In some embodiments, the electronic device is provided as a terminal. FIG. 17 is a block diagram of a terminal 1700 according to an embodiment. The terminal 1700 may be a portable mobile terminal, for example, a smartphone, a tablet computer, a Moving Picture Experts Group Audio Layer III (MP3) player, a Moving Picture Experts Group Audio Layer IV (MP4) player, a laptop computer, or a desktop computer. The terminal 1700 may also be referred to as user equipment, a portable terminal, a laptop terminal, a desktop terminal, or the like.

Generally, the terminal 1700 includes at least one processor 1701 and at least one memory 1702.

The processor 1701 includes one or more processing cores, for example, a 4-core processor or an 8-core processor. The processor 1701 may be implemented by using at least one of the following hardware forms: digital signal processing (DSP), a field-programmable gate array (FPGA), and a programmable logic array (PLA). The processor 1701 may alternatively include a main processor and a coprocessor. The main processor is configured to process data in an awake state, also referred to as a central processing unit (CPU), and the coprocessor is a low-power processor configured to process data in a standby state. In some embodiments, the processor 1701 may be integrated with a graphics processing unit (GPU). The GPU is configured to be responsible for rendering and drawing content that a display needs to display. In some embodiments, the processor 1701 may further include an artificial intelligence (AI) processor. The AI processor is configured to process computing operations related to machine learning.

The memory 1702 may include one or more computer-readable storage media, which may be non-transitory. The memory 1702 may further include a volatile memory or a nonvolatile memory such as one or more magnetic disk storage devices and a flash storage device. In some embodiments, the non-transitory computer-readable storage medium in the memory 1702 is configured to store at least one instruction. The at least one instruction, when executed by the processor 1701, causes the processor 1701 to perform the method for adding watermark information and the method for extracting watermark information according to the method embodiments of the present disclosure.

In some embodiments, the terminal 1700 may further include a peripheral device interface 1703 and at least one peripheral device. The processor 1701, the memory 1702, and the peripheral device interface 1703 may be connected through a bus or a signal cable. Each peripheral device is connected to the peripheral device interface 1703 through a bus, a signal cable, or a circuit board. In some embodiments, the peripheral device includes at least one of the following: a radio frequency circuit 1704, a display 1705, a camera assembly 1706, an audio circuit 1707, a positioning component 1708, and a power supply 1709.

The peripheral device interface 1703 may be configured to connect at least one peripheral device related to input/output (I/O) to the processor 1701 and the memory 1702. In some embodiments, the processor 1701, the memory 1702, and the peripheral device interface 1703 are integrated into the same chip or circuit board; in some other embodiments, any one or two of the processor 1701, the memory 1702, and the peripheral device interface 1703 are implemented on an independent chip or circuit board. This is not limited in the embodiments of the present disclosure.

The radio frequency circuit 1704 is configured to receive and transmit a radio frequency (RF) signal, also referred to as an electromagnetic signal. The radio frequency circuit 1704 communicates with a communications network and another communications device by using the electromagnetic signal. The radio frequency circuit 1704 may convert an electric signal into an electromagnetic signal for transmission, or convert a received electromagnetic signal into an electric signal. In some embodiments, the radio frequency circuit 1704 includes an antenna system, an RF transceiver, one or more amplifiers, a tuner, an oscillator, a digital signal processor, a codec chip set, a subscriber identity module card, and the like. The radio frequency circuit 1704 may communicate with another terminal through at least one wireless communication protocol. The wireless communication protocol includes, but is not limited to: a metropolitan area network, generations of mobile communication networks (2G, 3G, 4G, and 5G), a wireless local area network and/or a Wireless Fidelity (Wi-Fi) network. In some embodiments, the radio frequency circuit 1704 further includes a near field communication (NFC) related circuit, and is not limited in the present disclosure.

The display 1705 is configured to display a user interface (UI). The UI includes a graph, a text, an icon, a video, and any combination thereof. In the case that the display 1705 is a touch display, the display 1705 is further capable of acquiring a touch signal on or above a surface of the display 1705. The touch signal is inputted to the processor 1701 for processing as a control signal. In this case, the display 1705 is further configured to provide a virtual button and/or a virtual keyboard, which is also referred to as a soft button and/or a soft keyboard. In some embodiments, one display 1705 may be disposed on a front panel of the terminal 1700. In some other embodiments, at least two displays 1705 may be disposed on different surfaces of the terminal 1700 respectively or in a folded design. In still other embodiments, the display 1705 is flexible, disposed on a curved surface or a folded surface of the terminal 1700. Even, the display 1705 is further set in a non-rectangular irregular pattern, namely, a special-shaped screen. The display 1705 may be prepared by using materials such as a liquid crystal display (LCD), an organic light-emitting diode (OLED), or the like.

The camera assembly 1706 is configured to acquire an image or a video. In some embodiments, the camera assembly 1706 includes a front-facing camera and a rear-facing camera. Generally, the front-facing camera is disposed on a front panel of the terminal, and the rear-facing camera is disposed on a back surface of the terminal. In some embodiments, at least two rear-facing cameras are provided, which are respectively any one of a main camera, a depth-of-field camera, a wide-angle camera, and a telephoto camera, to implement a background blurring function by fusing the main camera and the depth-of-field camera, and panoramic shooting and virtual reality (VR) shooting functions or other fusing shooting functions by fusing the main camera and the wide-angle camera. In some embodiments, the camera assembly 1706 further includes a flash. The flash is a single color temperature flash, or a double color temperature flash. The double color temperature flash is a combination of a warm light flash and a cold light flash, and is used for light compensation under different color temperatures.

The audio circuit 1707 includes a microphone and a speaker. The microphone is configured to collect sound waves of a user and an environment, and convert the sound waves into electric signals and input the electrical signals into the processor 1701 for processing, or input the electrical signals into the radio frequency circuit 1704 to implement voice communication. For stereo sound collection or noise reduction, a plurality of microphones are provided, which are respectively disposed at different parts of the terminal 1700. The microphone may be further an array microphone or an omnidirectional collection microphone. The speaker is configured to convert electric signals from the processor 1701 or the radio frequency circuit 1704 into sound waves. The speaker is a conventional thin-film speaker or a piezoelectric ceramic speaker. In the case that the speaker is the piezoelectric ceramic speaker, electric signals are not only converted into sound waves audible to humans, but also converted into sound waves inaudible to humans for ranging and other purposes. In some embodiments, the audio circuit 1707 further includes an earphone jack.

The positioning component 1708 is configured to position a current geographic location of the terminal 1700 to implement navigation or a location-based service (LBS). The positioning component 1708 may be the United States' Global Positioning System (GPS), Russia's Global Navigation Satellite System (GLONASS), China's BeiDou Navigation Satellite System (BDS), or the European Union's Galileo Satellite Navigation System (Galileo).

The power supply 1709 is configured to supply power for various components in the terminal 1700. The power supply 1709 is an alternating current, a direct current, a disposable battery, or a rechargeable battery. In the case that the power supply 1709 includes the rechargeable battery, the rechargeable battery is a wired rechargeable battery or a wireless rechargeable battery. The rechargeable battery is further configured to support a fast charge technology.

In some embodiments, the terminal 1700 further includes one or more sensors 1710. The one or more sensors 1710 include, but are not limited to: an acceleration sensor 1711, a gyroscope sensor 1712, a pressure sensor 1713, a fingerprint sensor 1714, an optical sensor 1715, and a proximity sensor 1716.

The acceleration sensor 1711 detects acceleration on three coordinate axes of a coordinate system established by the terminal 1700. For example, the acceleration sensor 1711 is configured to detect components of gravity acceleration on the three coordinate axes. The processor 1701 controls, according to a gravity acceleration signal collected by the acceleration sensor 1711, the touch display 1705 to display the user interface in a landscape view or a portrait view. The acceleration sensor 1711 is further configured to collect game or user motion data.

The gyroscope sensor 1712 detects a body direction and a rotation angle of the terminal 1700. The gyroscope sensor 1712 cooperates with the acceleration sensor 1711 to collect a 3D action performed by the user on the terminal 1700. The processor 1701 implements the following functions according to the data collected by the gyroscope sensor 1712: motion sensing (such as changing the UI according to a tilt operation of the user), image stabilization at shooting, game control, and inertial navigation.

The pressure sensor 1713 is disposed on a side frame of the terminal 1700 and/or a lower layer of the display 1705. In the case that the pressure sensor 1713 is disposed on the side frame of the terminal 1700, a holding signal of the user on the terminal 1700 is detected. The processor 1701 performs left and right-hand recognition or a quick operation according to the holding signal collected by the pressure sensor 1713. In the case that the pressure sensor 1713 is disposed on the lower layer of the touch display 1705, the processor 1701 controls an operable control on the UI according to a pressure operation of the user on the touch display 1705. The operable control includes at least one of a button control, a scroll bar control, an icon control, and a menu control.

The fingerprint sensor 1714 is configured to collect a fingerprint of a user, and the processor 1701 identifies an identity of the user according to the fingerprint collected by the fingerprint sensor 1714, or the fingerprint sensor 1714 identifies an identity of the user according to the collected fingerprint. In the case that the identity of the user is identified as a trusted identity, the processor 1701 authorizes the user to perform a related sensitive operation. The sensitive operation includes unlocking a screen, viewing encrypted information, downloading software, payment, changing settings, and the like. The fingerprint sensor 1714 is disposed on a front surface, a back surface, or a side surface of the terminal 1700. In the case that the terminal 1700 is provided with a physical button or a vendor logo, the fingerprint sensor 1714 is integrated with the physical button or the vendor logo.

The optical sensor 1715 is configured to collect ambient light intensity. In an embodiment, the processor 1701 controls display brightness of the touch display 1705 according to the ambient light intensity collected by the optical sensor 1715. In some embodiments, in the case that the ambient light intensity is relatively high, the display brightness of the display 1705 is turned up. In the case that the ambient light intensity is relatively low, the display brightness of the display 1705 is turned down. In another embodiment, the processor 1701 further dynamically adjusts a camera parameter of the camera assembly 1706 according to the ambient light intensity collected by the optical sensor 1715.

The proximity sensor 1716, also referred to as a distance sensor, is usually disposed on the front panel of the terminal 1700. The proximity sensor 1716 is configured to collect a distance between a user and the front surface of the terminal 1700. In an embodiment, In the case that the proximity sensor 1716 detects that the distance between the user and the front surface of the terminal 1700 gradually decreases, the display 1705 is controlled by the processor 1701 to switch from a screen-on state to a screen-off state. In the case that the proximity sensor 1716 detects that the distance between the user and the front surface of the terminal 1700 gradually increases, the display 1705 is controlled by the processor 1701 to switch from the screen-off state to the screen-on state.

A person skilled in the art may understand that the structure shown in FIG. 17 does not constitute a limitation to the terminal 1700, and the terminal may include more or fewer components than those shown in the figure, or some components may be combined, or a different component deployment may be used.

In some embodiments, the electronic device is provided as a server. FIG. 18 is a schematic structural diagram of a server according to an embodiment. The server 1800 may vary greatly due to different configurations or performance and may include at least one central processing unit (CPU) 1801 and at least one memory 1802, wherein the at least one memory 1802 has at least one instruction stored therein, the at least one instruction being loaded and executed by the at least one CPU 1801 to perform the method according to the method embodiments described above. The server further includes components such as a wired or wireless network interface, a keyboard, and an input/output interface, for input and output. The server further includes other components for implementing the functions of the device, which is not described herein.

In an exemplary embodiment, a non-transitory computer-readable storage medium storing at least one instruction therein is further provided. The at least one instruction, when executed by a processor of an electronic device, causes the electronic device to perform the above method for adding watermark information and the method for extracting watermark information.

In an exemplary embodiment, a computer program product including at least one instruction therein is further provided. The at least one instruction, when executed by a processor of an electronic device, further causes the electronic device to perform the above method for adding watermark information and the method for extracting watermark information.

In an exemplary embodiment, a method for adding watermark information is provided. the method includes:

acquiring a plurality of audio signal frames in a first audio signal;

acquiring a plurality of watermark information items in watermark information;

determining an adding parameter of each of the watermark information items in each of the audio signal frames, wherein the adding parameter at least includes a target position;

and

acquiring a second audio signal added with the watermark information by adding each of the watermark information items to each of the audio signal frames based on the adding parameter of the watermark information item in the audio signal frame.

In some embodiments, the adding parameter further includes an information strength, and acquiring the second audio signal frame added with the watermark information by adding each of the watermark information items to each of the audio signal frames based on the adding parameter of the watermark information item in the audio signal frame includes:

acquiring the second audio signal frame by adding, based on the target position and the information strength of each of the watermark information items in each of the audio signal frames, the watermark information item matching the information strength to the corresponding target position.

In some embodiments, adding each of the watermark information items to each of the audio signal frames based on the adding parameter of the watermark information item in the audio signal frame includes:

acquiring parameter information of the plurality of audio signal frames, wherein the parameter information includes at least one of amplitude information or phase information; and

adjusting the parameter information of each of the audio signal frames based on the adding parameter of each of the watermark information items in the audio signal frame.

All embodiments of the disclosure may be implemented alone or in combination with other embodiments and are considered to be within the scope of the disclosure as claimed.

What is claimed is:

1. A method for adding watermark information, executed by an electronic device, the method comprising:
acquiring M first audio signal frames in a first audio signal, where M is a positive integer larger than 1;
acquiring N watermark information items in watermark information, where N is a positive integer larger than 1;
determining M*N adding parameters, wherein each of the adding parameters corresponds to one of the watermark information items and one of the first audio signal frames;
acquiring M second audio signal frames added with the watermark information based on the M*N adding parameters, wherein the second audio signal frame added with the watermark information is acquired by adding the N watermark information items to the first audio signal frame based on N adding parameters, wherein the N adding parameters correspond to the first audio signal frame and correspond to N watermark information items; and
determining a second audio signal based on the M second signal frames added with the watermark information.

2. The method according to claim 1, wherein the adding parameter comprises a target position and an information strength; and said acquiring M second audio signal frames added with the watermark information based on the M*N adding parameters comprises:
acquiring the second audio signal frame added with the watermark information by adding each of the N watermark information items in the first audio signal frame based on the target position and the information strength.

3. The method according to claim 1, wherein said acquiring M second audio signal frames added with the watermark information based on the M*N adding parameters comprises:
acquiring parameter information of the first audio signal frame, wherein the parameter information comprises at least one of amplitude information or phase information; and
acquiring the second audio signal frame added with the watermark information by adjusting the parameter information of the first audio signal frame based on the N watermark information items and the N adding parameters corresponding to the first audio signal frame.

4. The method according to claim 1, further comprising:
acquiring the first audio signal by transforming a third audio signal;
wherein the third audio signal is a time domain audio signal, and the first audio signal is a time-frequency domain audio signal.

5. The method according to claim 1, wherein said acquiring the N watermark information items in the watermark information comprises:
acquiring converted watermark information by performing binary conversion on the watermark information; and
determining the N watermark information items based on N bits in the converted watermark information, wherein each bit corresponds to one watermark information item.

6. The method according to claim 5, wherein said acquiring the converted watermark information by performing binary conversion on the watermark information comprises:
acquiring binary watermark information by performing the binary conversion on the watermark information; and
determining converted watermark information corresponding to the binary watermark information according to a reference conversion relationship, wherein the reference conversion relationship comprises converted binary numbers corresponding to original binary numbers.

7. The method according to claim 1, wherein the adding parameter comprises a target position;
said acquiring M second audio signal frames added with the watermark information based on the M*N adding parameters comprises:
adjusting the first audio signal frame by using the following formula:
$$\{ \begin{matrix}{P}_{w} ( n , k ) = P ( n , k ) \cdot {Mask}_{b} ( n , k ) \cdot x , & if I ( b ) = 1 \\ {P}_{w} ( n , k ) = P ( n , k ) \cdot {Mask}_{b} ( n , k ) / y , & if I ( b ) = 0\end{matrix} ;$$
wherein n represents the first audio signal frame, k represents a central frequency of the first audio signal frame, P (n,k) represents parameter information of the first audio signal frame, P_{w}(n,k) represents the parameter information of the second audio signal frame added with the watermark information, I (b) represents a b^{th} watermark information item in the watermark information, Mask_{b}(n,k) represents the target position corresponding to the b^{th} watermark information item in the audio signal frame, b represents a positive integer, and x and y represent reference values.

8. The method according to claim 2, wherein said acquiring the second audio signal frame added with the watermark information by adding each of the N watermark information items in the first audio signal frame based on the target position and the information strength comprises:
adjusting the first audio signal frame by using the following formula:
$$\{ \begin{matrix}{P}_{w} ( n , k ) = P ( n , k ) \cdot {Mask}_{b} ( n , k ) \cdot {10}^{\frac{{s}_{b}}{20}} , & if I ( b ) = 1 \\ {P}_{w} ( n , k ) = P ( n , k ) \cdot {Mask}_{b} ( n , k ) / {10}^{\frac{{s}_{b}}{20}} , & if I ( b ) = 0\end{matrix} ;$$
wherein n represents the first audio signal frame, k represents a central frequency of the first audio signal frame, P(n,k) represents parameter information of the first audio signal frame, P_{w} (n,k) represents the parameter information of the second audio signal frame added with the watermark information, I (b) represents a b^{th} watermark information item in the watermark information, Mask_{b} (n,k) represents the target position corresponding to the b^{th} watermark information item in the audio signal frame, and s_{b} represents the information strength corresponding to the b^{th} watermark information item in the audio signal frame.

9. The method according to claim 1, wherein said determining M*N adding parameters comprises:
encrypting the watermark information according to a reference key corresponding to the watermark information; and
determining the M*N adding parameters based on the encrypted watermark information and a reference function.

10. A method for extracting watermark information, executed by an electronic device, the method comprising:
acquiring a second audio signal added with watermark information;
determining N adding parameters in a second audio signal frame of the second audio signal, wherein each of the adding parameters corresponds to one watermark information item in the watermark information, and N is a positive integer;
acquiring N decoded watermark information items, wherein one decoded watermark information item corresponds to one watermark information item; and
extracting watermark information from the second audio signal frame based on the N adding parameters and the N decoded watermark information items.

11. The method according to claim 10, wherein the adding parameter comprises a target position and an information strength; and said extracting watermark information from the second audio signal frame based on the N adding parameters and the N decoded watermark information items comprises:
extracting the watermark information from the second audio signal frame based on the target positions and information strengths of the N adding parameters in the second audio signal frame and the N decoded watermark information items.

12. The method according to claim 10, wherein the adding parameter comprises a target position; and said extracting watermark information from the second audio signal frame based on the N adding parameters and the N decoded watermark information items comprises:
acquiring parameter information of the second audio signal frame, wherein the parameter information comprises at least one of amplitude information or phase information;
acquiring a plurality of target parameter information in the second audio signal frame based on the target positions of the N adding parameters; and
extracting the watermark information from the plurality of target parameter information based on the N adding parameters and the N decoded watermark information items.

13. The method according to claim 12, wherein said acquiring the plurality of target parameter information in the second audio signal frame based on the target positions of the N adding parameters comprises:
acquiring a plurality of converted parameter information in the second audio signal frame based on the target positions of the N adding parameters; and
determining the plurality of target parameter information according to a reference conversion relationship and the plurality of converted parameter information, wherein each piece of the target parameter information and the converted parameter information is binary information, and the reference conversion relationship comprises converted binary numbers corresponding to original binary numbers.

14. The method according to claim 10, wherein the adding parameter comprises a target position; and said extracting watermark information from the second audio signal frame based on the N adding parameters and the N decoded watermark information items comprises:
acquiring a plurality of target parameter information in the second audio signal frame based on the target position of each of the watermark information items in the second audio signal frame;
determining relevancy of watermark information items corresponding to any two pieces of target parameter information adjacent to each other based on the any two pieces of target parameter information and two of the decoded watermark information items corresponding to the any two pieces of target parameter information; and
extracting the watermark information items corresponding to the any two pieces of target parameter information from the second audio signal frame based on the relevancy.

15. The method according to claim 14, wherein said determining the relevancy of the watermark information items corresponding to the any two pieces of target parameter information adjacent to each other based on the any two pieces of target parameter information and the two of the decoded watermark information items corresponding to the any two pieces of target parameter information comprises:
determining the relevancy by using the following formula:
C=P_{w}^{e,f}·W^{e,f};
wherein C represents the relevancy, P_{w}^{e,f} represents target parameter information acquired by combining target parameter information corresponding to an e^{th} watermark information item and target parameter information corresponding to an f^{th} watermark information item, W^{e,f} represents a decoded watermark information item acquired by combining two of the decoded watermark information items corresponding to P_{w}^{e,f}, and the e^{th} watermark information item and the f^{th} watermark information item represent any two watermark information items adjacent to each other.

16. The method according to claim 14, wherein said extracting the watermark information items corresponding to the any two pieces of target parameter information from the second audio signal frame based on the relevancy comprises:
extracting watermark information items 1 from the second audio signal frame in response to the relevancy being a first reference value; or
extracting watermark information items 0 from the second audio signal frame in response to the relevancy being a second reference value.

17. The method according to claim 14, wherein the adding parameter further comprises an information strength; and said extracting watermark information from the second audio signal frame based on the N adding parameters and the N decoded watermark information items comprises:
determining the relevancy corresponding to the watermark information items by using the following formula:
C=P_{w}^{e,f}·W^{e,f}=(P^{e,f}±W^{e,f})·W^{e,f}=P^{e,f}·W^{e,f}+(n+m)s²;
wherein n represents a quantity of target positions corresponding to an e^{th} watermark information item, m represents a quantity of target positions corresponding to an f^{th} watermark information item, s represents an information strength of the e^{th} watermark information item and the f^{th} watermark information item, P^{e,f} represents parameter information acquired by combining parameter information corresponding to the e^{th} watermark information item and parameter information corresponding to the f^{t} watermark information item before the watermark information is added;
extracting watermark information items 1 from the second audio signal frame in response to
$$\vert \frac{C}{( n + m ) {s}^{2}} \vert$$
being not less than a reference threshold and the relevancy being a first reference value; or
extracting watermark information items 0 from the second audio signal frame in response to
$$\vert \frac{C}{( n + m ) {s}^{2}} \vert$$
being not less than the reference threshold and the relevancy being a second reference value.

18. The method according to claim 17, further comprising:
extracting watermark information items from the second audio signal frame based on the relevancy and confidence in response to
$$\vert \frac{C}{( n + m ) {s}^{2}} \vert$$
being less than the reference threshold, wherein the confidence represents credibility of the watermark information items extracted based on the relevancy.

19. The method according to claim 10, wherein said determining N adding parameters in the second audio signal frame comprises:
acquiring decrypted watermark information by decrypting the watermark information according to a reference key corresponding to the watermark information; and
determining the N adding parameters according to the reference key and a reference function.

20. An electronic device, comprising:
at least one processor; and
a volatile or nonvolatile memory configured to store at least one instruction executable by the at least one processor;
wherein the at least one processor, when executing the at least one instruction, is caused to perform:
acquiring M first audio signal frames in a first audio signal, where M is a positive integer larger than 1;
acquiring N watermark information items in watermark information, where N is a positive integer larger than 1;
determining M*N adding parameters, wherein each of the adding parameters corresponds to one of the watermark information items and one of the first audio signal frames;
acquiring M second audio signal frames added with the watermark information based on the M*N adding parameters, wherein the second audio signal frame added with the watermark information is acquired by adding the N watermark information items to the first audio signal frame based on N adding parameters, wherein the N adding parameters correspond to the first audio signal frame and correspond to N watermark information items; and
determining a second audio signal based on the M second signal frames added with the watermark information
